(19) United States
(12) Patent Application Publication
(10) Pub. No.: US 2025/0053148 A1
(43) Pub. Date: Feb. 13, 2025

(54) SPEED-DEPENDANT BLENDING BETWEEN BLOCKS WITH DISCONTINUOUS TRAJECTORIES

(71) Applicant: Siemens Aktiengesellschaft, 80333 München (DE)

(72) Inventor: RALF SPIELMANN, Stuttgart (DE)

(73) Assignee: Siemens Aktiengesellschaft, 80333 München (DE)

(21) Appl. No.: 18/848,007

(22) PCT Filed: Feb. 20, 2023
(86) PCT No.: PCT/EP2023/054172

§ 371 Date: Sep. 17, 2024

(30) Foreign Application Priority Data
Mar. 18, 2022 (EP) 22162987.6

(51) Int. Cl. G05B 19/402; G05B 19/29

(52) U.S. Cl. CPC G05B 19/402; G05B 19/296

(57) ABSTRACT

In a method for operating a machine having a trajectory determined by a parts program and including multiple block transitions with a non-tangential contour, a high trajectory speed and a short operating time are achieved. For a first position-controlled axis, an acceleration duration different from a first period duration can be specified, wherein a transition maximum speed for the first position-controlled axis is determined such that, when the first position-controlled axis moves with the transition maximum speed and the transition maximum acceleration is applied, the speed of the first position-controlled axis has a value of zero at the end of the acceleration duration. The traversing movement is determined such that the speed of the first position-controlled axis, at the transition from a first trajectory section to a second trajectory section, does not exceed the transition maximum speed.

The invention relates to an operating method for a machine which has a plurality of position-controlled axes which in their entirety, in connection with a numerical control facility, cause a traversing movement of a first element of the machine relative to a second element of the machine, wherein the traversing movement is predefined using program instructions which define a trajectory with a large number of adjacent path sections, wherein the numerical control facility ascertains position setpoints for the position-controlled axes from the program instructions in an interpolation cycle with a predefined first period, wherein a first program instruction defines a first path section and an immediately following second program instruction defines a second path section immediately adjacent to the first path section, and wherein at a contact point the first and second path sections merge into one another in a manner that is not continuously differentiable.

Further, the invention relates to a machine system for carrying out such a method.

Furthermore, the invention relates to a machine, in particular a machine tool or a robot, for such a machine system.

Furthermore, the invention relates to a numerical control facility, in particular a CNC controller or a path controller, for such a machine system.

In addition, the invention relates to a digital twin of such a numerical control facility.

From the publication DE60012815T2 a numerical control facility is known in which cycle data can be generated individually. The numerical control facility makes it possible to set a first interpolation cycle for a first group of axes controlled by the numerical control facility and a second interpolation cycle different from the first interpolation cycle for a second group of axes controlled by the numerical control facility which is different from the first group.

Known from the document EP 1424613 B1 is a method for machining workpieces by means of a multi-axis handling device, such as an industrial robot, with a tool moved in accordance with a control unit of the handling device, wherein the tool can be a laser machining tool, in which mirrors are approached by means of the control unit in a multiple of an interpolation cycle.

Published, unexamined patent application EP 2738635 A1 discloses a numerical control facility comprising: a local path filter which locally interpolates an interpolation interval under a tool path so that a variation in a differential value at the interpolation object point becomes a continuous variation, wherein the interpolation interval has a specific interval width before and after an interpolation object point; and a pulse interpolation unit which, when a specific command instructing a deceleration or an acceleration of a transfer object is input to a command input apparatus, derives a reference time which advances per reference unit of time, which is shortened or lengthened by a degree corresponding to the deceleration.

Known from the publication “INTELLIGENT LÖSUNGEN FOR WERKZEUGMASCHINEN” [Intelligent Solutions for Machine Tools]—Sinumerik (2021 edition)”; Sinumerik Family Brochure DE; pp.: 1-36; XP055955751 are a CNC controller and a digital twin of the CNC controller, in which the digital twin of the CNC controller is an integral part of the CNC controller.

From the function manual “SINUMERIK ONE Basisfunktionen” [SINUMERIK ONE Basic Functions], Siemens Industry Online Support—Product Support, Jul. 1, 2021, pages 1-874, XP055955296, a path control mode is known from chapter 6.3 “Path control mode”, pages 458 ff, in particular chapter 6.3.2 “Speed reduction according to overload factor”, pages 460 ff, in which braking of the path axes to speed zero at the block change point is avoided and the path changes to the next block with the same path speed as far as possible.

The path control mode causes “kinked” block transitions to be made tangential or smoothed by local changes to the programmed course. The extent of the change relative to the programmed course can be limited by the criteria of the overload factor or grinding.

The “speed reduction according to overload factor” function reduces the path speed in path control mode to such an extent that the non-tangential block transition can be exceeded in an interpolator cycle (also known as interpolation cycle or IPO cycle for short) while maintaining the acceleration limit and taking an overload factor into account.

When the speed is reduced, axial “speed Jumps” which can be carried out within one IPO cycle are generated when the contour is non-tangential at the block transition. The speed jump prevents the path speed from having to be reduced to zero during the block transition. The jump is carried out when the axial speed has been reduced with the axis acceleration to a speed from which the jump can then reach the new setpoint. The jump height of the setpoint can be limited by means of the “overload factor” criterion. Since the jump height is axis-related, the block transition takes into account the smallest jump height of the path axes active during a block change. Since all axes involved can jump to different heights, the criterion is the smallest jump height, otherwise the smallest jump height of an axis would be violated.

The disadvantage of the last-mentioned function is that the path speed decreases, in particular if the trajectory is determined by a parts program with many block transitions with a non-tangential, i.e. not continuously differentiable, contour profile.

An object of the invention is therefore to disclose an operating method for a machine in which a high path speed and, as a result, a short machining time are achieved even with a trajectory which is determined by a parts program with many block transitions with a non-tangential contour profile.

To achieve this object, the invention provides that in an operating method of the type mentioned in the introduction an acceleration duration different from the first period can be predefined for at least one first position-controlled axis, wherein a transition maximum acceleration is predefined for the first position-controlled axis, wherein a transition maximum speed is ascertained for the first position-controlled axis such that when the first position-controlled axis moves with the transition maximum speed by applying the transition maximum acceleration, the speed of the first position-controlled axis at the end of the acceleration duration has the value zero, and wherein the traversing movement is ascertained in such a way that the speed of the first position-controlled axis during the transition from the first path section to the second path section does not exceed the transition maximum speed, wherein a technology cycle different from the interpolation cycle with a second period (TD1, TD2, TD3) is predefined in the numerical control facility (3) and wherein the second period (TD1, TD2, TD3) is set as the acceleration duration.

The invention offers the advantage that the acceleration duration can be predefined independently of the IPO clock in the case of block transitions which result in a discontinuous trajectory and would therefore require “speed jumps” of individual axes to implement them with a particular path speed which is different from zero can be predefined by the IPO cycle. The user is no longer limited to the period of exactly one IPO cycle.

In particular with a short IPO cycle (for example 2 ms and below), this means that the axis speeds of individual axes no longer have to be braked to very low axis speeds during block transitions so that the axis can be braked to v=0 within this short IPO cycle.

The invention provides that a technology cycle, which is different from the interpolation cycle, with a second period is predefined in the numerical control facility, wherein the second period is set as the acceleration duration.

This offers the advantage that other functions can also be set via a technology cycle defined in this way and different from the IPO cycle, in particular functions for which a very short IPO cycle does not make sense for clocking the respective function. An example of this would be the recording of the temperature for a temperature compensation which is known per se.

One embodiment of the invention provides that the second period is an integral multiple of the first period. A technology cycle that is not completely detached from the IPO cycle offers technical advantages, both in terms of implementation and synchronization of various processes or functions in the numerical control facility.

One embodiment of the invention provides that the cycle edges of the technology cycle lie on cycle edges of the interpolation cycle.

This embodiment offers the advantage that the technology cycle is particularly well adapted to the IPO cycle and the two cycles can therefore be synchronized particularly well.

One embodiment of the invention provides that the first period does not exceed 5 ms and is, in particular, in the range from 1 ms to 3 ms.

The advantages of the invention come into effect in particular with very short IPO cycles with a period of less than 5 ms, typically 1 ms to 3 ms.

One embodiment of the invention provides that the second period does not fall below 5 ms and is, in particular, in the range from 8 ms to 20 ms.

This means that if there is a discontinuous block transition, there is still enough time to brake an axis to v=0 within one cycle, assuming an axis speed that is still acceptable.

The invention can be applied particularly advantageously when turning or milling a workpiece by means of a machine tool, since block transitions with a discontinuous trajectory often occur, in particular during these machining operations.

For milling and even more so for turning, speed-dependent grinding is the most relevant type of “corner rounding” and consequently the most efficient way of reducing machining time. With todays IPO cycles from, for example, 4 ms the “speed jumps” in the axes mean a vibration excitation of 125 Hz. This is an excitation which, as a rule, is not critical for machine tools since typical natural frequencies of the machines are up to 40 Hz. With IPO cycles in the range of 8 ms to 10 ms, for high-quality machines the upper limit for operation of speed-dependent grinding will lie. Consequently, a technology cycle of 8 to 10 ms would be ideal for such machines, although the IPO cycle should be in the range of 1 to 2 ms in order to continue to be able to use the described advantages of small IPO cycles.

The IPO cycle is usually set by the OEM (Original Equipment Manufacturer) of the numerical control facility and cannot be changed by the end user.

The use of a technology cycle which is different from the IPO cycle offers the advantage that this—in addition to being predefined by the control manufacturer—can also advantageously be designed to be adjustable by an OEM or the end user. This allows the end user maximum flexibility.

One embodiment of the invention provides that the transition maximum acceleration is composed of a predefinable maximum axis acceleration and a predefinable overload factor.

The maximum axis acceleration predefined by the machine manufacturer applies, in particular, to longer acceleration distances or acceleration durations of the axis. This value can also be exceeded for a short time without overloading or overheating the axis drive. The overload factor indicates by what value the maximum axis acceleration may be exceeded (for a short time). Typical overload factors are in the range from 1.1 to 2.0 or, analogously, as percentages between 10% and 100%. The overload factors can also range up to 20, depending on how long or short the effective technology cycle is.

This value can also be advantageously set by the control manufacturer, the OEM, the machine manufacturer or the end user.

One embodiment of the invention provides that the second period is set in a program instruction for speed-dependent grinding, in particular in a G-code instruction, in particular in a G64 Instruction.

This embodiment offers the advantage that existing parts programs can continue to be used.

One embodiment of the invention provides that different acceleration durations and/or different transition maximum accelerations can be set for positive acceleration and for negative acceleration of the first position-controlled axis.

This can, for example, take into account the fact that during braking of an axle, the friction of the axle supports the braking process, whereas during positive acceleration, additional axle forces have to be applied to overcome the friction. The drive of an axle, which is limited to a particular maximum power supply and thus to a particular maximum torque for positive acceleration or braking, can therefore achieve higher axle accelerations during braking of the axle (decrease in speed) than during positive acceleration when accelerating positively (increase in speed).

The object mentioned in the introduction is further achieved by a machine system for carrying out a method as claimed in one of claims 1 to 10, comprising a machine which has a plurality of position-controlled axes which in their entirety, in connection with a numerical control facility, cause a traversing movement of a first element of the machine relative to a second element of the machine,
wherein the traversing movement can be predefined using program instructions which define a trajectory with a large number of adjacent path sections,
wherein position setpoints for the position-controlled axes can be ascertained by means of the numerical control facility from the program instructions in an interpolation cycle with a predefined first period,
wherein a first program instruction defines a first path section and an immediately following second program instruction defines a second path section immediately adjacent to the first path section,
wherein at a contact point the first and the second path sections merge into one another in a manner that is not continuously differentiable,
wherein an acceleration duration which is different from the first period can be predefined for at least a first position-controlled axis,
wherein a transition maximum acceleration can be predefined for the first position-controlled axis,
wherein a transition maximum speed is ascertained for the first position-controlled axis (by means of the numerical control facility) In such a way that when the first position-controlled axis moves with the transition maximum speed by applying the transition maximum acceleration, the speed of the first position-controlled axis has the value zero at the end of the acceleration duration,
wherein the traversing movement can be ascertained in such a way that the speed of the first position-controlled axis does not exceed the transition maximum speed during the transition from the first path section to the second path section,
wherein a technology cycle, which is different from the interpolation cycle, with a second period is predefined in the numerical control facility and wherein the second period is set as the acceleration duration.

The object mentioned in the introduction is further achieved by a numerical control facility, in particular a CNC controller or a path controller, for a machine of a machine system as claimed in claim 11.

The object mentioned in the introduction is also achieved by a digital twin of a numerical control facility as claimed in claim 13.

The Invention will be described and explained in more detail below using exemplary embodiments. In the drawings:

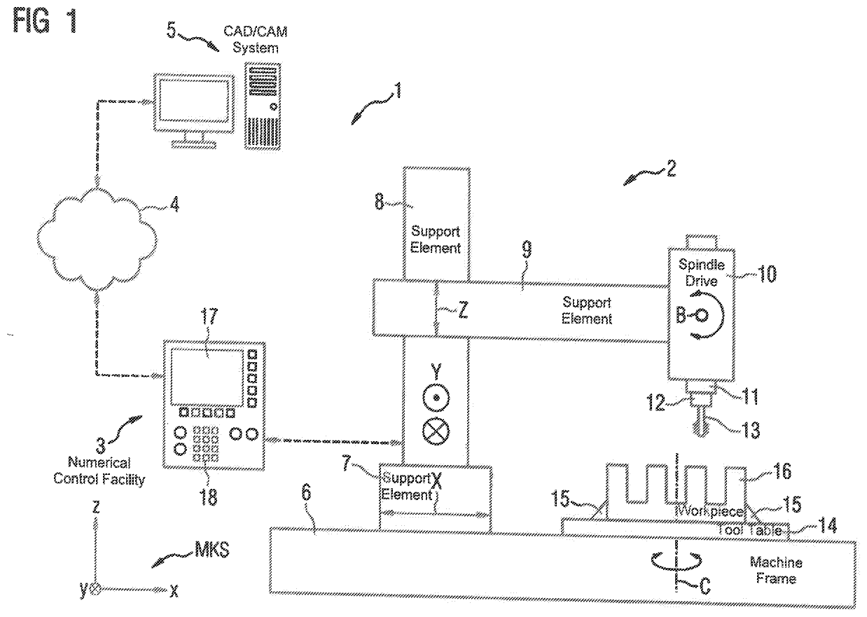

FIG. 1 shows a machine tool system for carrying out an inventive method,

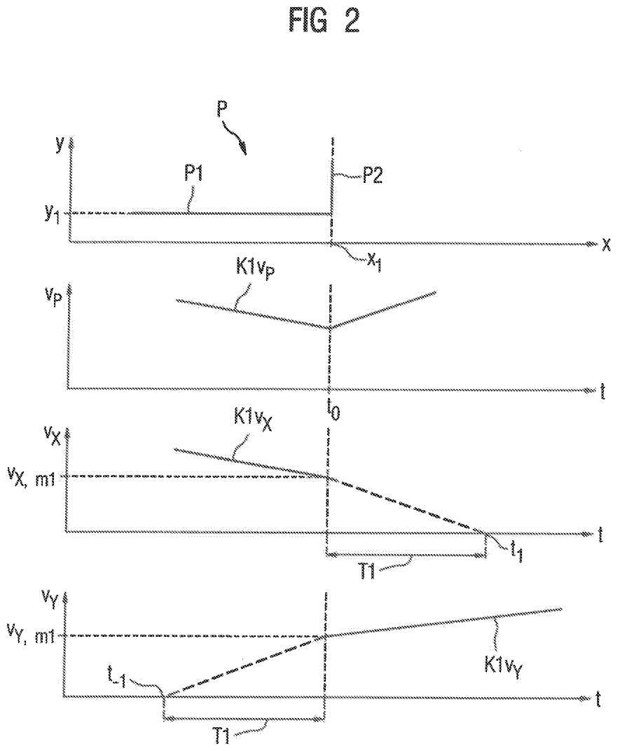

FIG. 2 shows a first block transition in a parts program,

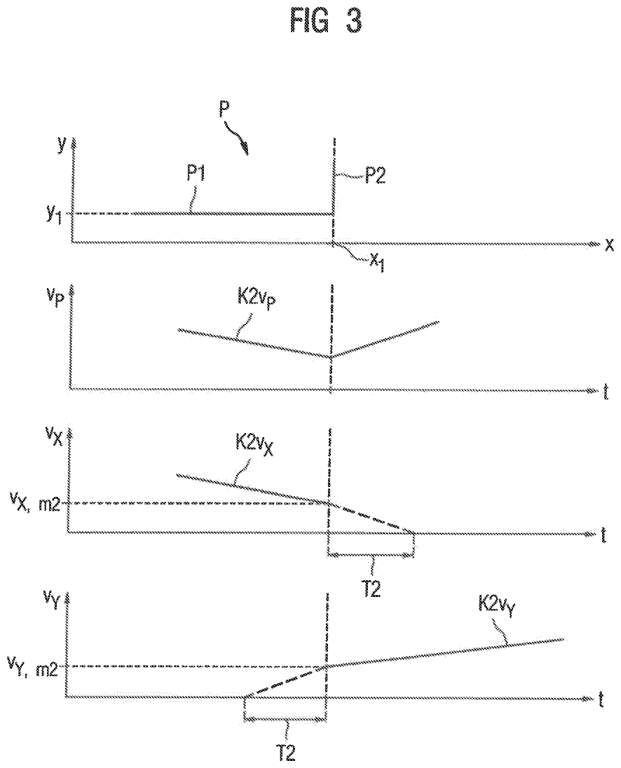

FIG. 3 shows a second block transition in a parts program,

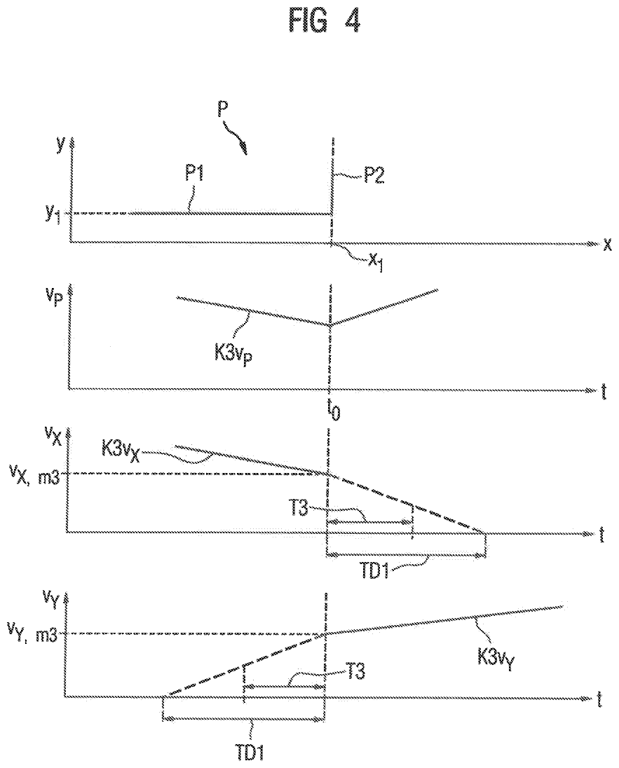

FIG. 4 shows a block transition in a parts program with an acceleration duration which is different from the period of the IPO cycle,

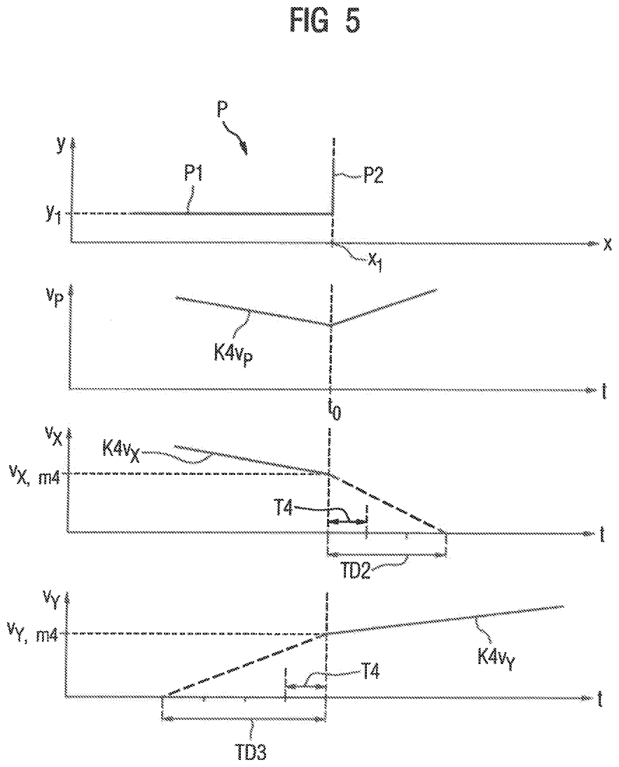

FIG. 5 shows a block transition in a parts program with different acceleration durations for the acceleration processes of the axes involved and different from the period of the IPO cycle,

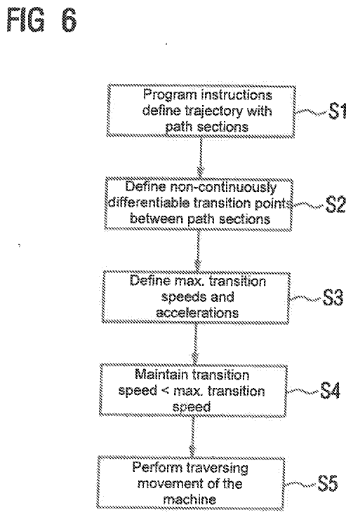

FIG. 6 shows method steps in carrying out an inventive method.

FIG. 1 schematically represents a machine tool system in the form of a machine tool system 1. The machine tool system 1 comprises a metal-cutting machine in the form of a machine tool 2. The machine tool system 1 further comprises a numerical control facility connected to the machine tool 2 in the form of a CNC controller 3 for controlling the machine tool 2. In addition, the machine tool system 1 comprises an external computing device in the form of a CAD/CAM system 5, which is connected via a network 4, for example the Internet.

The represented machine tool 2 has three position-controlled linear axes X, Y and Z, with a first support element 7 being adjustable in the x-direction, a second support element 8 being adjustable in the y-direction and a third support element 9 being adjustable in the z-direction in respect of a machine coordinate system MKS which is stationary in respect of the machine tool 2.

The first support element 7 is connected to a stationary machine frame 6 via a linear drive (not shown) which is adjustable in the x-direction, the second support element 8 is connected to the first support element 7 via a linear drive (not shown) which is adjustable in the y-direction and the third support element 9 is connected to the second support element 8 via a linear drive (not shown) which is adjustable in the z-direction.

The third support element 9 carries a spindle drive 10 which in turn can be pivoted about a position-controlled rotary axis B which is parallel to the Y-axis. The spindle drive 10 in turn has a speed- and/or position-controlled tool spindle 11 which can be rotated about a spindle axis (not shown) and in which a tool holder 12 with the tool 13 attached thereto is clamped.

Furthermore, the machine tool 2 comprises a speed- and/or position-controlled tool table axis C which is oriented parallel to the Z axis and around which a workpiece table 14 can be rotated.

The tool table 14 is also connected to the stationary machine frame 6 and a workpiece 16 is fastened to the tool table 14 by means of the tool holders 15.

In the context of the exemplary embodiment, the machine tool 2 therefore has five position-controlled machine axes through which a relative movement between the tool 13, which is in the form of a milling cutter in the exemplary embodiment, and the workpiece 16 can be carried out. It is therefore what is known as a 5-axis machine tool (5-axis machine), although it should be noted at this point that a machine tool can of course also have more, but also fewer than five machine axes. The drives of the position-controlled machine axes were not represented in the exemplary embodiment for the sake of better clarity.

The machine tool 2 is connected to the CNC controller 3, which uses a parts program stored in the CNC controller 3 and/or a manual control input to ascertain movement setpoints for the machine axes to control a relative movement taking place between the tool 13 and the workpiece 16. The CNC controller 3 ascertains the movement setpoints preferably using the parts program in which the movements to be carried out by the tool 13 relative to the workpiece 16 are defined in the form of commands or program instructions, as a rule in the form of G-code.

Alternatively or in addition, the movement of the tool 13 and/or the workpiece 16 can also be predefined by an operator in situ at the machine tool 2 using a manual control input via an operating facility with operating elements 18 in conjunction with a display device in the form of a display 17 of the CNC controller 3. The operating elements 18 include, in particular, buttons or rotary controls. The display 17 can advantageously also be designed as a touchscreen and thus also as a control element.

The parts program is usually generated in a computing facility that is external from the perspective of the CNC controller, in the exemplary embodiment the CAD/CAM system 5 and what is known as a postprocessor (not represented) possibly connected downstream of the CAD/CAM system outside the CNC controller 3 and transferred from there, in particular via the network 4, to the CNC controller 3.

Alternatively, the parts program can also have been generated directly on the CNC controller 3, for example as part of what is known as a JobShop application or cycle programming.

When executing the parts program, the CNC controller 3 generates position setpoints x, y and z for the linear axes as well as angular position setpoints β and γ for the rotary axes in a particular cycle, the interpolation cycle. These movement setpoints move the tool 13 with a predefined orientation relative to the workpiece 16 along a movement path (path).

In addition to the pure position setpoints, the dynamics of the relative movement or the variables relating to the individual axes, in particular the speed, acceleration and jerk, can also be ascertained or set by means of the CNC controller 3.

Figures FIG. 2 and FIG. 3 illustrate exemplary blocks or a block transition (also referred to as a block change) in a parts program, which describe a corner of a tool path P, the tool path P running parallel to the x-direction in a first path section P1 up to the corner and from the corner point (x₁, y₁) runs parallel to the y-direction in a second path section P2 which immediately follows the first path section P1. The x- or y-direction in respect of the contour should correspond to the X- or Y-axis of the machine. Of course, the embodiments described in the exemplary embodiment to simplify this special case can be transferred analogously to any tool paths running in the space in the machine coordinate system or in respect of the machine axes with a non-tangential transition between path sections.

The corner with the corner point (x₁, y₁) in the exemplary embodiment therefore represents a non-tangential or non-continuously differentiable trajectory of the tool path P, and this means that the axes do not have to execute technically impossible speed jumps in order to travel along the path P at a particular speed.

Different approaches are known for solving this problem:

According to a first solution, the path speed v_{P} can be reduced in its course up to the speed v_{P}=0 in the corner and then—after the corner—increase again. Although this variant would be true to the contour, it would result in long machining times and possibly undesirable vibrations on the machine.

According to a second solution, which is considered in more detail here, the axes are not braked to a standstill, and this shortens the machining time, but inevitably results in at least minor deviations from the target contour.

In the first, upper diagram, FIG. 2 illustrates the path P with the visible corner in the contour in the xy plane. A first block of the parts program describes the movement of the tool along the first path section P1 in the x direction up to the value x=x₁. A second block following the first block describes the movement in the y-direction, starting from the corner point (x₁, y₁), along the second path section P2. The block change or block transition thus describes a non-tangential or non-continuously differentiable trajectory, in the exemplary embodiment a 90° corner.

As already indicated, the path should also be moved in the region of the corner at a speed v_{P}>0. This is Illustrated in FIG. 2 by the second diagram visible below the first illustration. The vertex (x₁, y₁) is reached at a time t=t₀ at which the path speed v_{P} has a value v_{P}>0.

The diagrams below in FIG. 2 illustrate the speed curve of the X- and Y-axes.

At time t=t₀, the X-axis has the transition maximum speed v_{X,m1} (third diagram) and the Y-axis has the transition maximum speed v_{Y,m1} (fourth diagram). v_{x,m1} and v_{y,m1} are determined and set by the numerical control facility (CNC controller) in such a way that the X-axis accelerates (in particular brakes) exactly in an IPO cycle, starting from the axis speed v_{X}, mᵢ, with the transition maximum acceleration a_{X,m1} (not represented) and at the end of the IPO cycle T1 (at a time t=t₁) reaches the value vₓ=0.

In a similar way, the Y-axis is (positively) accelerated from v_{Y}=0, starting at time t=t₁ and thus exactly the duration of an IPO cycle T1 (both the cycle itself and its period are referred to below as “T . . . ”) before the time t₀, with the transition maximum acceleration a_{Y,m1}, so that the Y-axis has the transition maximum speed v_{Y,m1} at the time t=t₀.

The slopes of the characteristic curves shown for the speed curve represent the acceleration of the axis in question. The transition maximum acceleration (not represented) thus represents the slope of the speed characteristic curve K1v_{X} or K1v_{Y} for the respective part of the relevant characteristic curve respectively shown in broken lines in which the maximum acceleration is present respectively. The transition maximum acceleration for the respective axis consists of a maximum acceleration aₘₐₓ predefined for the respective axis and an overload factor f, in the form:

$${a}_{X , m 1} = {a}_{X , max} * {f}_{X}$$

$${a}_{Y , m 1} = {a}_{Y , max} * {f}_{Y}$$

Preferably the overload factor is in the range

$$1 < f \leq 2$$

FIG. 3 illustrates the same situation with the difference that the control used has an IPO cycle T2 that is only half as long compared to the previous one in this case.

With otherwise identical conditions, it can be seen from the comparison of FIGS. 2 and 3 and, in particular, from the comparison of the speed curves K1_{X} or K1v_{Y} and K2v_{X} or K2v_{Y} that with (half) the IPO clock T2, the corresponding transition maximum speeds v_{X,m2} or v_{Y,m2} halve compared to v_{X,m1} and v_{Y,m1}. The path speed in the region of the corner (x₁,y₁), as can be seen from the characteristic curve K2v_{P}, therefore slows down significantly, and this, for example for a workpiece in which a rectangular pocket is to be milled, can result in a significantly longer machining time overall for machining of the workpiece in question.

FIG. 4 accordingly illustrates the inventive situation in which an acceleration duration TD1 which is different from the period of the IPO cycle T3 is predefined for the acceleration processes of the axes involved. A technology cycle TD1 is defined with exactly this acceleration duration TD1, which in the exemplary embodiment has twice the period of the evident IPO cycle T3. In addition, the cycle edges of the technology cycle TD1 are on the cycle edges of the IPO cycle T3, and this can be seen from the drawing because both cycles start at t=t₀.

As can be seen from FIG. 4, the control works internally, for example when ascertaining position setpoints, with the shorter IPO cycle T3, whereas the longer technology cycle TD1 is effective for the speed change at the block transition. This enables both highly precise position control and a high path speed during a block change with a discontinuous trajectory.

Technically, the “speed jump” distributed over a plurality of (in the exemplary embodiment exactly 2) IPO cycles can be implemented, for example by a buffer for the IPO cycle, the depth of which corresponds to the number of IPO cycles over which the jump is to be made, in the exemplary embodiment thus also exactly two.

FIG. 5 illustrates an inventive embodiment in which different acceleration durations, different from the period T4 of the IPO cycle, are predefined for the acceleration processes of the axes involved.

The acceleration duration for braking the X-axis is thus a time period TD2 which corresponds to three IPO cycles T4.

For positive acceleration, an acceleration duration TD3 is provided for the Y-axis, which corresponds to four IPO cycles T4.

This procedure offers the greatest possible flexibility when defining the maximum acceleration duration for the relevant axis during a block change.

The essential method steps when carrying out an inventive method will be explained again in the form of a flowchart according to FIG. 6.

In a first method step S1, a traversing movement for a machine which has a plurality of position-controlled axes which in their entirety, in connection with a numerical control facility, cause a traversing movement of a first element of the machine relative to a second element of the machine, is predefined using program instructions (stored in the numerical control facility) which define a trajectory with a large number of adjacent path sections.

In a method step S2, the numerical control facility ascertains position setpoints for the position-controlled axes from the program instructions in an interpolation cycle with a predefined first period, wherein a first program instruction defines a first path section and an immediately following second program instruction defines a second path section immediately adjacent to the first path section and wherein, at a contact point, the first and second path sections merge into one another in a manner that is not continuously differentiable. This means that the trajectory has a bend or a corner and in order to travel through the path at a particular path speed, (technically impossible) jumps in speed of the machine axes involved in the movement would be required in the region of the bend.

In a method step S3, the numerical control facility ascertains a transition maximum speed for at least one first position-controlled axis as a function of a predefined acceleration duration which is different from the first period and a predefined transition maximum acceleration in such a way that when the first position-controlled axis moves with the transition maximum speed by applying the transition maximum acceleration, the speed of the first position-controlled axis has the value zero at the end of the acceleration duration.

Alternatively or in addition, the numerical control facility ascertains a transition maximum speed for at least one second position-controlled axis as a function of a predefined acceleration duration which is different from the first period and a predefined transition maximum acceleration, such that when the second position-controlled axis moves starting from a transition initial speed, in particular the transition initial speed v=0, by applying the transition maximum acceleration, the speed of the second position-controlled axis has the transition maximum speed at the end of the acceleration duration.

In a method step S4, the numerical control facility ascertains the traversing movement in such a way that the speed of the first and/or the second position-controlled axis during the transition from the first path section to the second path section does not exceed the ascertained maximum transition speed.

In a method step S5, the numerical control facility carries out the ascertained traversing movement in the machine.

What is claimed is:

1.-13. (canceled)

14. A method for operating a machine having a plurality of position-controlled axes controlled by a numerical control facility, which cause a traversing movement of a first element of the machine relative to a second element of the machine, the method comprising:
predefining the traversing movement using program instructions which define a path having a plurality of adjacent path sections,
determining with the numerical control facility position from the program instructions setpoints for the plurality of position-controlled axes in an interpolation cycle having a predefined first period,
predefining in the numerical control facility a technology cycle with a second period different from the interpolation cycle, with the second period being set as an acceleration duration,
defining in a first program instruction a first path section and defining in an immediately following second program instruction a second path section immediately adjacent to the first path section, with the first path section transitioning in the second path section at a contact point without being continuously differentiable at the contact point,
defining for at least one first position-controlled axis an acceleration duration that is different from the first period,
defining for the at least one first position-controlled axis a transition maximum acceleration,
predefining for the at least one first position-controlled axis a transition maximum speed such that, when the at least one first position-controlled axis moves with the transition maximum speed and the transition maximum acceleration is applied, a speed of the at least one first position-controlled axis has a value of zero at the end of the acceleration duration, and
determining the traversing movement so that the speed of the at least one first position-controlled axis does not exceed the transition maximum speed when transitioning from the first path section to the second path section.

15. The method of claim 14, wherein the second period is an integral multiple of the first period.

16. The method of claim 15, wherein cycle edges of the technology cycle lie on cycle edges of the interpolation cycle.

17. The method of claim 14, wherein the first period does not exceed 5 ms.

18. The method of claim 14, wherein the first period is in a range from 1 ms to 3 ms.

19. The method of claim 14, wherein the second period does not fall below 5 ms.

20. The method of claim 14, wherein the second period is in a range from 8 ms to 20 ms.

21. The method of claim 14, wherein the machine is embodied as a machine tool configured for turning or milling a workpiece.

22. The method of claim 14, wherein the technology cycle is set by a machine manufacturer or a machine operator.

23. The method of claim 14, wherein the transition maximum acceleration is determined as a function of a predefined maximum axis acceleration and a predefined overload factor of the at least one first position-controlled axis.

24. The method of claim 14, wherein the second period is set in a program instruction for speed-dependent grinding.

25. The method of claim 24, wherein the program instruction is selected from a G-code instruction and a G64 instruction.

26. The method of claim 14, further comprising setting different acceleration durations or different transition maximum accelerations can be set for a positive acceleration and for a negative acceleration of the at least one first position-controlled axis.

27. A machine system, comprising:
a machine having a plurality of position-controlled axes; and
a numerical control facility designed to cause a traversing movement of a first element of the machine relative to a second element of the machine;
wherein the machine system carries out the method set forth in claim 14.

28. A numerical control facility controlling a machine having a plurality of position-controlled axes, the numerical control facility designed to cause a first element of the machine to perform a traversing movement relative to a second element of the machine and to carry out the method set forth in claim 14.

29. The numerical control facility of claim 28, embodied as a CNC controller or a path controller.
